(19) United States
(12) Patent Application Publication
(10) Pub. No.: US 2013/0268717 A1
(43) Pub. Date: Oct. 10, 2013

(54) EMULATED ELECTRICALLY ERASABLE MEMORY HAVING SECTOR MANAGEMENT

(71) Applicants: Ross S. Scouller, Austin, TX (US); Daniel L. Andre, Austin, TX (US); Frank K. Baker, JR., Austin, TX (US); Jeffrey C. Cunningham, Austin, TX (US)

(72) Inventors: Ross S. Scouller, Austin, TX (US); Daniel L. Andre, Austin, TX (US); Frank K. Baker, JR., Austin, TX (US); Jeffrey C. Cunningham, Austin, TX (US)

(21) Appl. No.: 13/442,028

(22) Filed: Apr. 9, 2012

(51) Int. Cl. G06F 12/00

(52) U.S. Cl. 711/103; 711/E12.008

(57) ABSTRACT

A semiconductor memory device comprises a volatile memory and a non-volatile memory including a plurality of sectors. Each of the plurality of sectors configured to store a sector status indicator and a plurality of data records. A control module is coupled to the non-volatile memory and the volatile memory. The control module manages the sectors by scanning the sectors to identify the records with invalid data; changing the status indicator of a particular sector when all of the records in the particular sector are invalid, and discontinuing scanning the particular sector while all of the records in the particular sector are invalid.

### BACKGROUND

1. Field

This disclosure relates generally to memory systems, and more specifically, to method of operating an emulated electrically erasable (EEE) memory.

2. Related Art

Emulated electrically erasable (EEE) memories typically use a random access memory and a non-volatile memory that is electrically erasable combined to provide a memory system that has increased endurance over a regular non-volatile memory for a comparable size to that of the random access memory. This is achieved using a non-volatile memory much larger than the random access memory but EEE memory operates as if it were only the size of the random access memory. Thus the EEE memory emulates an electrically erasable memory of a reduced size from that which is used by the EEE memory but with an increase in endurance. This is useful in situations in which endurance is very important such as automotive applications in which data is updated often and must be stored in a non-volatile manner. This also useful by having smaller erasable units.

One problem common to EEE memories is that there can occasionally be long delays in being able to write data into the non-volatile memory because of too many locations in a sector in the non-volatile memory have data that is divided between valid data and invalid data. So before those locations can be written again, the sector must be erased but before the erase operation the locations with valid data must be written elsewhere. When this occurs. there may be a substantial amount of time required to perform all the necessary operations to perform the write operation. Sequential reading is time consuming as well. Also of concern in operation is that it can take significant time to identify which location in the non-volatile memory has the valid data.

Accordingly, there is a need to provide an EEE memory that improves upon the issue described above.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates in block diagram form a system, including an emulated electrically erasable memory using a non-volatile memory, useful in implementing an embodiment of the present invention;

FIG. 2 illustrates the RAM of FIG. 1 and, in more detail, the flash memory and a portion of the memory controller also of FIG. 1;

FIG. 3 illustrates a portion of the flash memory of FIG. 2 in more detail and in sequential stages of operation;

FIG. 4 illustrates a flow diagram of a first operation of the system of FIG. 1; and

FIG. 5 illustrates a flow diagram of a second operation of the system of FIG. 1.

### DETAILED DESCRIPTION

In one aspect an emulated electrically erasable (EEE) memory has a RAM and an NVM divided into sectors. Using either a copy down to the RAM or an update to the NVM, sectors are identified that do not have valid data and that thus need not be accessed to determine if they have valid data. This can also be effective when the RAM, volatile memory, is a software version which would also be volatile. This is better understood by reference to the drawings and the following description.

In one embodiment, a flash array is used as the NVM. In one example, and as used herein, programming refers to storing a logic level zero to a bitcell and erasing refers to storing a logic level one to a bitcell. However, in alternate embodiments, programming may refer to storing a logic level one to a bitcell and erasing may refer to storing a logic level zero to a bitcell. A logic level zero may also be referred to as a logic low and a logic level one may also be referred to as a logic high.

As used herein, the term “bus” is used to refer to a plurality of signals or conductors which may be used to transfer one or more various types of information, such as data, addresses, control, or status. The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

The terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

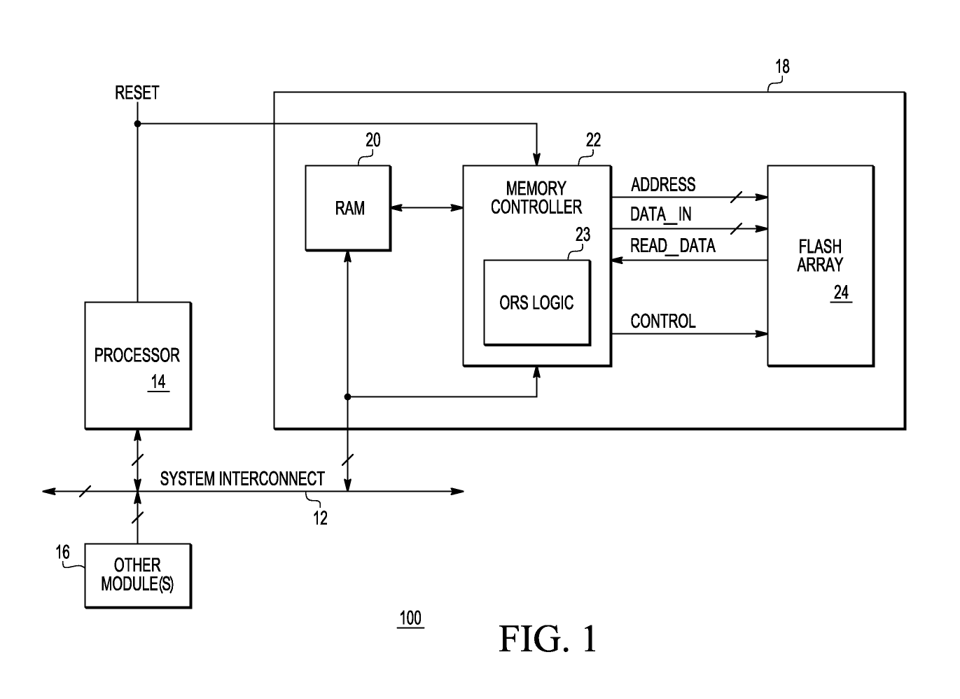

FIG. 1 illustrates, in block diagram form, a system 100 which includes a processor 14, other module(s) 16 (if any), a system interconnect 12, and an EEE memory system 18 (which may also be referred to as a memory system or a non-volatile memory system). Each of processor 14, other module(s) 16, and EEE memory system 18 are bidirectionally coupled to system interconnect 12. EEE memory system 18 includes a RAM 20, a memory controller 22, obsolete record sector (ORS) logic 23, and a flash array 24 (which may also be referred to as an NVM array, where any type of NVM may be used in place of the flash array). RAM 20, which may be considered a volatile memory, is bidirectionally coupled to system interconnect 12 and to memory controller 22. Memory controller 22 is coupled to system interconnect 12 and flash array 24. ORS logic 23, which is part of memory controller 22, is coupled to flash array 24. Memory controller 22 communicates control signals with flash array 24 and provides an address and data_in to flash array 24 and receives read_data from flash array 24. A reset signal is provided to processor 14 and memory controller 22. This reset signal may be, for example, a global reset signal for system 100.

Processor 14 can be any type of processor, such as a microprocessor, digital signal processor, etc., or may be any other type of interconnect master which can access EEE memory system 18. In one form, system interconnect 12 is a system bus. Other forms of interconnect may be used including, for example, crossbars, point-to-point connections, and optical and wireless transmission techniques. Other modules 16 may include any type of module, such as, for example, another memory, another processor, another interconnect master, a peripheral, an input/output (I/O) device, etc. Alternatively, no other modules may be present in system 10.

In operation, processor 14 can send access requests (read or write access requests) to memory system 18. The access requests from processor 14, which include an access address, and, in the case of a write access, associated write data, are provided to RAM 20. In the case of a read access, RAM 20 provides processor 14 the data stored at the received access address location. In the case of a write access, RAM 20 stores the received write data at the received access address location. In the case of a write access, memory controller 22 may detect an update of RAM 20 and selectively store the received access address and associated write data to flash array 24 in a logically sequential manner. For example, in the case of an update (a write) to RAM 20, the received access address and associated write data are used to form a record that is written to flash array 24 at the next available location. This next available location is logically sequential to a location that was loaded during an immediately preceding loading of flash array 24. (Note that, referring to FIG. 1, the received access address can be provided as address to flash array 24 and the associated write data as data_in to flash array 24.) In one example, the writing of the record corresponding to the RAM update is only performed if the value that is currently stored at the RAM location is different from the new write value associated with the write access request for that RAM location. In this manner, flash array 24 can store the values of RAM 20 which have been updated in a more permanent manner. That is, when RAM 20 loses power, its data is lost. Upon restoring power, the values of the RAM may be restored from flash array 24, which does not lose its data upon losing power. In one embodiment, flash array 24 has a greater storage capacity than RAM 20. For example, flash array 24 may have a capacity of at least four times greater than RAM 20 and typically much larger than that.

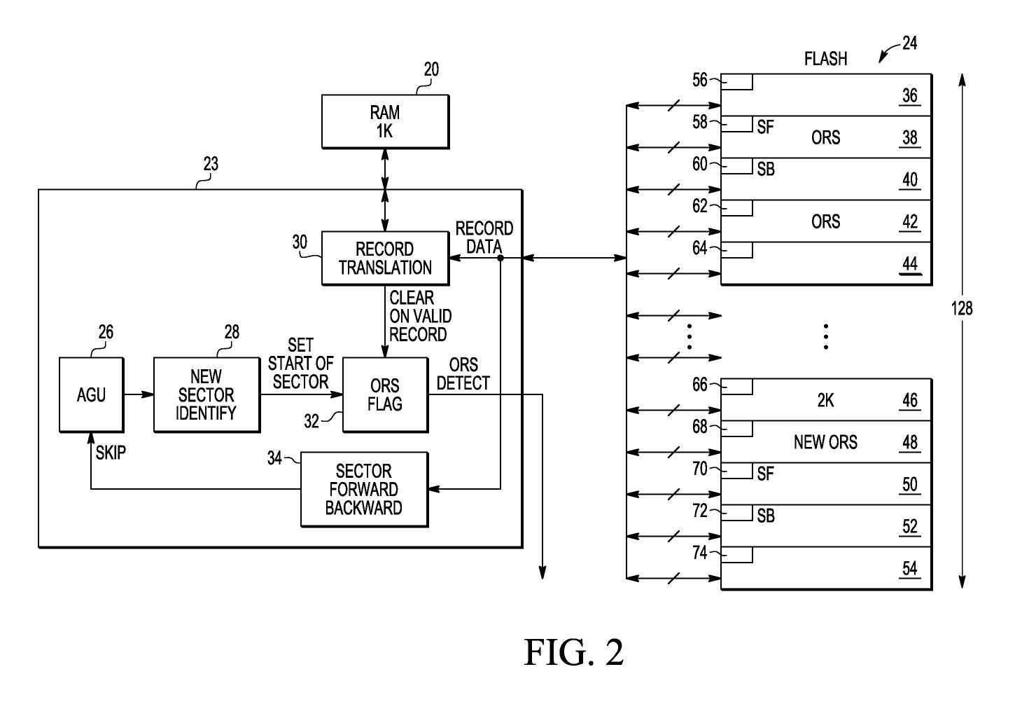

Shown in FIG. 2 is a portion of EEE memory system 18 of FIG. 1 including flash array 24, ORS (obsolete record sector) logic 23, and RAM 20. Flash array 24 may have 64 sectors for a 128 k block in which each sector has 2K of memory. Exemplary sectors include sectors 36, 38, 40, 42, and 44 in a top portion of Flash array 24 and sectors 46, 48, 50, 52, and 54 in a bottom portion of flash array 24. Sectors 36, 38, 40, 42, 44, 46, 48, 50, 52, and 54 have status locations 56, 58, 60, 62, 64, 66, 68, 70, 72, and 74, respectively. Each sector 36, 38, 40, 42, 44, 46, 48, 50, 52, and 54 is coupled to ORS logic 23. ORS logic 23 includes address generation unit (AGU) 26, a new sector identify circuit 28, a record translation circuit 30, an ORS flag 32, and a sector forward/backward circuit 34. AGU 26 has an output coupled to an input of new sector identify circuit 28, and an input coupled to an output of sector forward/backward circuit 34. Sector forward/backward circuit 34 has an input coupled to an input/output of record translation circuit 30 and flash array 24. New sector identify circuit 28 has an output coupled to an input of ORS flag 32. ORS flag 32 has an output coupled to a portion of memory controller 22 not shown in FIG. 2. Record translation circuit 30 has an output coupled to an input of ORS flag 32 and output coupled to RAM 20. In the condition shown in FIG. 2, flash array 24 has sectors 38 and 42 both in an obsolete condition which means that none of the stored data in those sectors are valid and there no locations available to be written with valid data. Status location 62 is set to “skip forward” which means that when the direction of action is in the direction from sector 36 to sector 44, the forward direction, sector 42 is to be skipped and thus save time. Similarly, status location 58 indicates skip forward so that sector 38 will be skipped in the same manner as sector 42. Status locations 60 and 64 are set to “skip back” to indicate that sectors 38 and 42 are to be skipped when action is progressing in the direction from sector 44 to sector 36, the backward direction. Sector 48 is shown as being a new ORS in that the last operation obsoleted the last valid record.

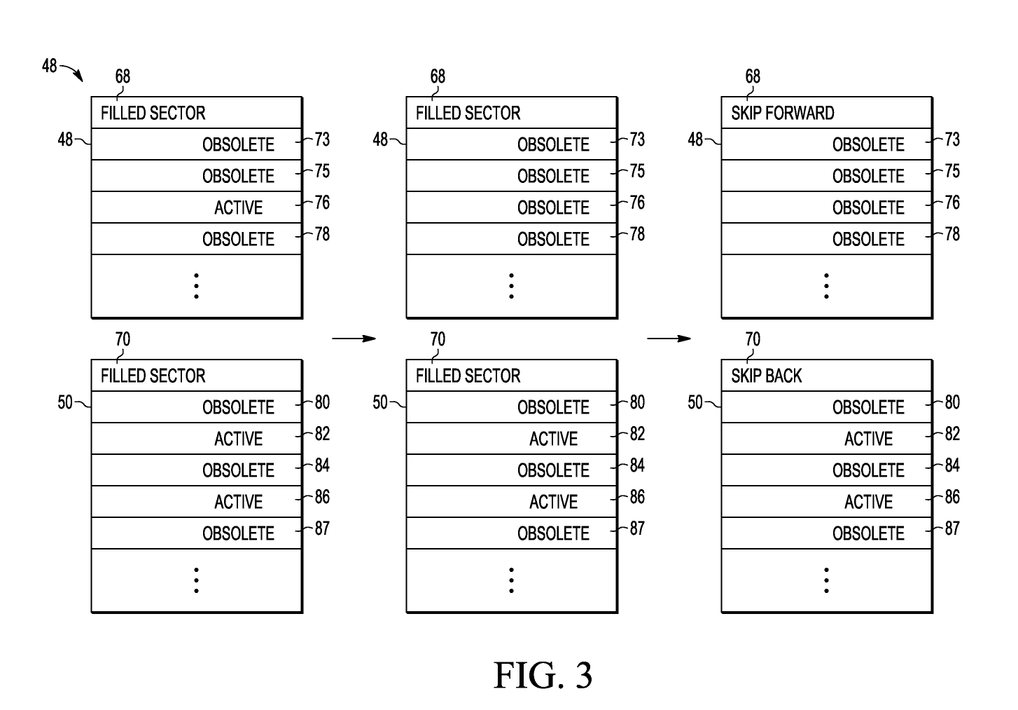

Shown in FIG. 3 are sectors 48 and 50 of FIG. 2 shown in more detail as changes occur in these sectors by arising from the last valid record of sector 48 being obsolete. Sector 48 has records 73, 75, 76, and 78 in which records 73, 75, and 78 are obsolete and record 76 is the last valid record as shown in the far left. At this same stage for sector 50 that has records 80, 82, 84, 86, and 87 in which records 82 and 86 are valid data, status locations 68 and 70 both indicate a status of “filled” indicating that there is no space for more valid data but valid data may be present. In the middle portion of FIG. 3, record 76 is obsoleted. When this occurs, there is no more valid data present in sector 48, but status location 68 is not immediately changed and stays in the filled sector state as does status location 70. A status flag is set in ORS flag circuit 32 when first entering the sector on sequential scans either forward or backward, which is reset upon finding valid data, thus remains set after completing the action in sector 48 which in turn causes status location 68 to be recorded for future change to skip forward and status location 70 to be recorded for future change to skip back as shown in the right most portion of FIG. 3. Thus, for future actions until compression requires otherwise, sector 48 will be skipped saving time based on status indicator in its status location or the status indicator in the status location of immediately adjacent sector below sector 48, which in this case is sector 50. Both status indicators skip forward in the status location for sector 48 and skip back in the status location in sector 50 are indicators that sector 48 contains only obsolete records and is thus an obsolete record sector (ORS).

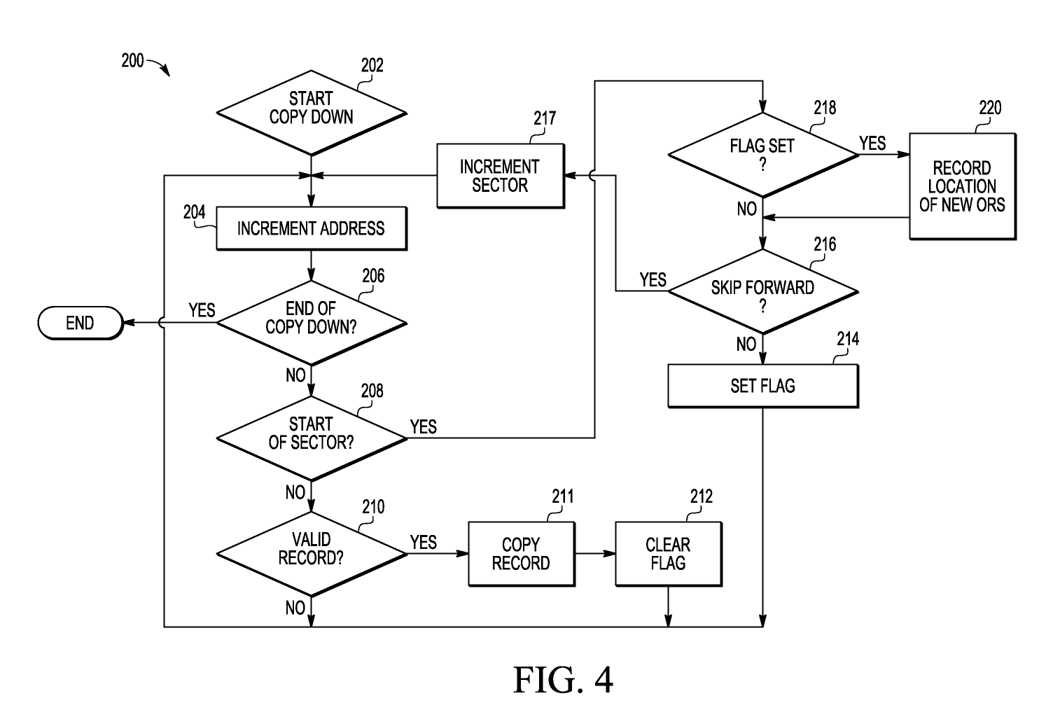

Shown in FIG. 4 is a flow chart showing a method 200 for performing a copy down 202 that will identify new obsolete sectors and skipping existing obsolete sectors. This is one type of scan of flash array 24. An increment address operation 204 begins with providing an address. The address will at some point indicate that the copy down has been completed and an end decision 206 will be yes. Of course, the first address will not be the end so end decision 206 is no at the beginning. Next a start of the sector decision is made at start of sector 208. The first address will normally be at the beginning of a sector such as sector 36. With the address at a beginning of the sector, if the flag is determined to not be set at flag set question 218, a determination is made at skip forward question 216. If the status location of the sector is skip forward then increment sector 217 is performed which has the effect of skipping that sector. Increment address 204 is then performed on the next sector. If the status location of the sector is not skip forward, then the flag is set at set flag 214. With the setting of the flag, the address is incremented at increment address 204. With the address incremented the next address, which is the second address, will not be at the end and will not be at the start of a sector. A determination is made at valid record question 210 if the record at that address is valid or not. If it is valid it is copied at copy record 211, the flag is cleared at clear flag 212, and the address is incremented. If on the other hand the determination is that the record is not valid, the address is incremented without clearing the flag. With the newly incremented address, the record is checked for validity at valid record question 210. If valid, the record is copied and the flag is cleared. When copied, the record will ultimately be entered into its proper location in RAM 20. If not valid, the flag is not cleared. Either way, the address is incremented. This process of incrementing and checking for validity and then either copying the record and clearing the flag before incrementing or simply incrementing continues until the start of the next sector is detected. If all of the decisions were that the record was not valid, then the flag remains set. If any of the decisions were that the record was valid, then the flag is cleared. The significance of the flag remaining set is that the sector contains no valid records. On the other hand if the flag is not set at this point, then the sector has at least one valid record.

Thus at the beginning of the next sector, a “yes” at start of sector 208 results in recognizing that flag set question 218 is yes which results in a record being made of a newly found ORS at record location of new ORS 220. This fact is ultimately recorded in the status locations of the sector that is obsolete and the sector immediately below the obsolete sector. The status location of the obsolete sector will have added to it “skip forward,” and the immediately following sector will have its status location updated with “skip backward.” This is shown in skip forward question 216 which indicates that skip forward is to be entered. The status location has enough bits that each newly added piece of information can be achieved without erasing any of the previously added information in the status locations. Thus, updating can occur without requiring erasing and thus the status locations can be part of the flash array that has its sectors normally erased only during compression.

Then with skip forward question 216 answered in the affirmative, the address is incremented, and since it is not at the end and not at a start of a sector, the process of determining if the record is valid or not continues. As described before, when the record is valid it is copied to RAM and the flag is cleared and then the address is incremented again. When the record is not valid, the address is incremented. In this way the address is incremented and a determination is made if the record is valid for all of the records in the sector. If the record is valid, it is copied. The flag is cleared and stays cleared after the first valid record is found. When the end of the record has been reached, if the flag is still set, then that record has no valid data and the appropriate status locations are updated. In this way, each record is processed to copy its valid data and determine if it is obsolete or skipped by increment sector 217. Only records at the beginning of a sector are checked for skip forward. Ultimately, end of search 206 will determine that the search has been completed. After first determining that there is an obsolete record and having the appropriate status location updated, that record will be skipped in method 200 as long as the updated status location remains in that state by increment sector 217.

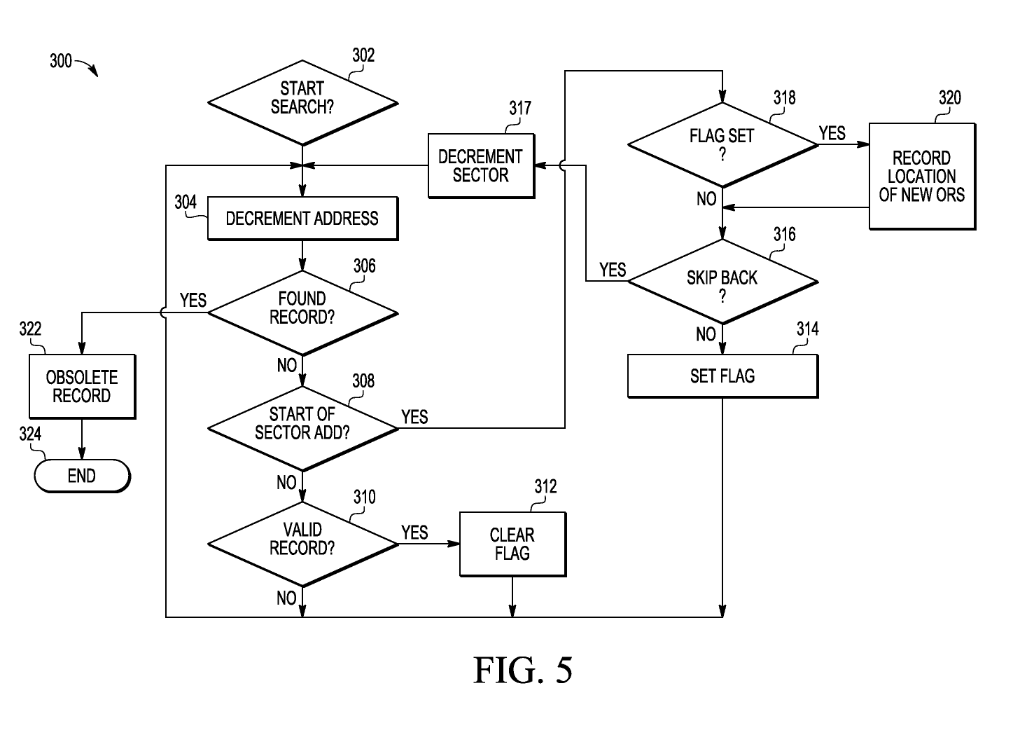

Shown in FIG. 5 is a flow chart of a method 300 for invalidating a record when updating flash array 24. Updating includes both writing the new data and also invalidating the record that is made obsolete in view of the new data being written. For example, sector 50 may be the sector currently being written and the next available record is then written with the new data. This is straightforward and not shown in method 300. Method 300 is for the invalidating portion of the updating process. Somewhere in flash array 24 is the current version of what is being updated which must be invalidated. By beginning the search with last written location and continuing in the last to first direction, the most recently written version will be found first. Once that occurs, that record is invalidated and the search is over. With the start of the search at start search 302, the address is decremented in decrement address 304 going from the most recent entry to the next most recent entry in the last to first direction. If the record being updated is found, it is obsoleted as shown in obsolete record 322 and method 300 is complete at end 324. If the record is not found, then a determination is made as to the address being at the beginning of the sector as shown as START OF SECTOR ADD?. If this is affirmative, then the flag is checked to see if it is set at flag set question 318. If the flag is not set, which would be the case for the sector currently being written, then the next step is to determine if the status location indicates skip back at skip back question 316. If the condition of the status is skip back, the sector address is decremented at decrement sector 317 and the next address is then at the next sector. For example, if sector 50 is the current sector then status location 70 would be being checked and if it said skip back, then the next location being checked would be status location 68. On the other hand if the status location does not indicate skip back, then the flag is set at set flag 314. The address is then decremented at decrement address 304. Then if the record under search is found at found record 306, then the record is obsoleted at obsolete record 322 and that again is the end. If the record is not found, then if the address is at the start of the sector then the method moves to flag set question 318 and proceeds as described previously. If the address is not at the start of the sector, then the record is checked to see if it is valid at valid record question 310. If the record is valid, then the flag is cleared at clear flag 312 and then the address is decremented and the method 300 continues with found record question 306. If the record is not valid, then the flag is not cleared, the address is decremented, and method 300 continues with found record question 306. When the start of the sector is reached, then method 300 continues with flag set question 318. The flag will be in the set condition if none of the records were found to be valid in the sector. Thus, if the flag is set that means the sector has no valid records and can be obsoleted which fact is recorded at record location of new ORS 320. This results in the status location of the sector having just been searched being set to skip forward and eventually the status location of the previous sector being set to skip back.

In the case of method 300, there is no certainty as to how many, if any, full sectors will be searched, but if a complete sector is searched and if all of the records are obsolete, then that fact can be stored and used to improve efficiency of searching for future searches by skipping that sector. The discovery of an ORS during method 300 can improve the efficiency of method 200 because status locations are loaded with skip forward information as a result of method 300. Skip forward is the obsolete indicator when using method 200. Similarly, the discovery of an ORS during method 200 can improve efficiency of method 300 because status locations are loaded with skip back information as a result of method 200. Skip back is the obsolete indicator when using method 300. Status locations can contain both skip back and skip forward obsolete indicators at the same time. This would occur when adjacent sectors are both obsolete.

Methods 200 and 300 both are run using memory controller 20 and under the general capability of a memory controller and further use ORS logic 23 which has configuration not known to having been used such as sector forward/backward and ORS flag 32. These components arise because of the ability to identify sectors that are obsolete and to direct the operations between RAM 20 and flash array 24 to skip sectors of flash array 24 when they are known to not have valid records.

By now it should be appreciated that there has been provided semiconductor memory device that includes a volatile memory and a a non-volatile memory including a plurality of sectors, each of the plurality of sectors configured to store a sector status indicator and a plurality of data records. The semiconductor memory device further includes a control module coupled to the non-volatile memory and the volatile memory, the control module is operable to manage the sectors including a control module coupled to the non-volatile memory and the volatile memory, the control module is operable to manage the sectors including scan the sectors to identify the data records with invalid data, change the sector status indicator of a particular sector when all of the data records in the particular sector are invalid, and discontinue scanning the particular sector while all of the records in the particular sector are invalid. The semiconductor memory device has a further characterization by which the control module is further operable to set an obsolete indicator when starting a scan of one of the sectors to indicate that all of the data records in the one of the sectors is invalid, scan the one of the sectors for data records that are invalid, change the obsolete indicator to indicate that at least one of the data records in the one of the sectors is valid when a valid data record is found in the one of the sectors, record a location of the one of the sectors when the scan of the one of the sectors is complete and the obsolete indicator is still set to indicate all of the data records in the one of the sectors is invalid, and change the status indicator of the one of the sector based on the obsolete indicator. The semiconductor memory device has a further characterization by which the control module is further operable to, when data is received in the non-volatile memory from the volatile memory write the data in a data record that is free in one of the sectors, search the sectors for a previously received version of the data, skip searching the sectors having the status indicator that indicates all of the data records in the particular sector are invalid, and when the previously received version of the data is found, mark the previously received version of the data record as invalid. The semiconductor memory device has a further characterization by which the control module is further operable to decrement an address to scan the sectors in order from most recently filled sectors to oldest filled sectors. The semiconductor memory device has a further characterization by which the control module is further operable to when data is sent to the volatile memory from the non-volatile memory search the sectors for valid versions of data, and when the valid version of data is sent to non-volatile memory, change the obsolete indicator to indicate that the valid version of data was found in the one of the sectors. The semiconductor memory device has a further characterization by which the control module is further operable to increment an address to scan the sectors in order from oldest filled sectors to most recently filled sectors. The semiconductor memory device has a further characterization by which the processing unit is further operable to compress valid data in the non-volatile memory by copying the valid data from sectors that include invalid data into one or more sectors that include only the valid data and change the status indicator for each of the sectors that include only the invalid data.

Also described is a method for managing a semiconductor memory device, wherein the semiconductor memory device includes a volatile memory, a non-volatile memory including a plurality of sectors, each of the plurality of sectors configured to store a plurality of data records, and a control module coupled to the non-volatile memory and the volatile memory. The method further includes setting an obsolete indicator when starting a scan of one of the sectors to indicate that all data records in the one of the sectors is invalid. The method further includes scanning the one of the sectors for invalid data records. The method further includes changing the obsolete indicator to indicate that at least one of the data records in the one of the sectors is valid when a valid data record is found in the sector. The method further includes recording a location of the one of the sectors when the scan of the one of the sectors is complete and the obsolete indicator is still set to indicate all of the data records in the one of the sectors is invalid. The method may further include changing a sector status indicator of the sector based on the obsolete indicator. The method may further include, when data is received in the non-volatile memory from the volatile memory, writing the data in a data record that is free in one of the sectors, searching the sectors for a previously received version of the data, skipping searching the sectors in which data in all of the data records in the particular sector are invalid, and when the previously received version of the data is found, marking the previously received version of the data as invalid. The method may further include decrementing an address to scan the sectors in order from most recently filled sectors to oldest filled sectors. The method may further include, when data is sent to the volatile memory from the non-volatile memory, searching the sectors for valid versions of data, skipping searching the sectors in which all of the records in the particular sector are invalid, and when the valid version of data are sent to non-volatile memory, changing the obsolete indicator to indicate that the valid version of data was found in the one of the sectors. The method may further include incrementing an address to scan the sectors in order from oldest filled sectors to most recently filled sectors. The method may further include compressing valid data in the non-volatile memory by copying the valid data from sectors that include invalid data into one or more sectors that include only the valid data and changing a status indicator for each of the sectors that include only the invalid data.

Described also is a computer processing system including a volatile memory. The computer processing system further including a volatile memory. The computer processing system further including a non-volatile memory including a plurality of sectors, each of the plurality of sectors configured to store one or more data records. The computer processing system further including a control module coupled to the non-volatile memory and the volatile memory, the control module is operable to manage the sectors including search the sectors for valid versions of data, skip searching the sectors in which all of the records in the particular sector are invalid, and when the valid versions of data are sent to the non-volatile memory, change an obsolete indicator to indicate that the valid version of data was found in the one of the sectors. The computer processing system may have a further characterization by which. The computer processing system may have a further characterization by which the control module is further operable to. The computer processing system may have a further characterization by which increment an address to scan the sectors in order from oldest filled sectors to most recently filled sectors. The computer processing system may have a further characterization by which when data is received in the non-volatile memory from the volatile memory, write the data in a free record in one of the sectors, search the sectors for a previously received version of the data, skip searching the sectors in which all of the records in the particular sector are invalid, and when the previously received version of the data is found, mark the previously received version of the data as invalid. The computer processing system may have a further characterization by which wherein the control module is further operable to decrement an address to scan the sectors in order from most recently filled sectors to oldest filled sectors. The computer processing system may have a further characterization by which wherein the control module is further operable to compress valid data in the non-volatile memory by copying the valid data from sectors that include invalid data into one or more sectors that include only the valid data, and change a status indicator for each of the sectors that include only the invalid data. The computer processing system may have a further characterization by which the control module is further operable to set the obsolete indicator when starting a search of one of the sectors to indicate that all of the data in the one of the sectors is invalid, scan the one of the sectors for the invalid data, change the obsolete indicator to indicate that at least one of the data in the one of the sectors is valid when valid data is found in the one of the sectors, and record a location of the one of the sectors when the scan of the one of the sectors is complete and the obsolete indicator is still set to indicate all of the data in the one of the sectors is invalid.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Although the invention is described herein with reference to specific embodiments, various modifications and changes can be made without departing from the scope of the present invention as set forth in the claims below. For example, other features may be incorporated into the process. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A semiconductor memory device comprising:
a volatile memory;
a non-volatile memory including a plurality of sectors, each of the plurality of sectors configured to store a sector status indicator and a plurality of data records; and
a control module coupled to the non-volatile memory and the volatile memory, the control module is operable to manage the sectors including scan the sectors to identify the data records with invalid data,
change the sector status indicator of a particular sector when all of the data records in the particular sector are invalid, and
discontinue scanning the particular sector while all of the records in the particular sector are invalid.

2. The semiconductor memory device of claim 1 wherein the control module is further operable to:
set an obsolete indicator when starting a scan of one of the sectors to indicate that all of the data records in the one of the sectors is invalid;
scan the one of the sectors for data records that are invalid;
change the obsolete indicator to indicate that at least one of the data records in the one of the sectors is valid when a valid data record is found in the one of the sectors;
record a location of the one of the sectors when the scan of the one of the sectors is complete and the obsolete indicator is still set to indicate all of the data records in the one of the sectors is invalid; and
change the status indicator of the one of the sector based on the obsolete indicator.

3. The semiconductor memory device of claim 2 wherein the control module is further operable to:
when data is received in the non-volatile memory from the volatile memory:
write the data in a data record that is free in one of the sectors;
search the sectors for a previously received version of the data;
skip searching the sectors having the status indicator that indicates all of the data records in the particular sector are invalid; and
when the previously received version of the data is found, mark the previously received version of the data record as invalid.

4. The semiconductor memory device of claim 3 wherein the control module is further operable to:
decrement an address to scan the sectors in order from most recently filled sectors to oldest filled sectors.

5. The semiconductor memory device of claim 2 wherein the control module is further operable to:
when data is sent to the volatile memory from the non-volatile memory:
search the sectors for valid versions of data;
skip searching the sectors having the status indicator that indicates all of the records in the particular sector are invalid; and
when the valid version of data is sent to non-volatile memory, change the obsolete indicator to indicate that the valid version of data was found in the one of the sectors.

6. The semiconductor memory device of claim 5 wherein the control module is further operable to:
increment an address to scan the sectors in order from oldest filled sectors to most recently filled sectors.

7. The semiconductor memory device of claim 1 wherein the processing unit is further operable to:
compress valid data in the non-volatile memory by copying the valid data from sectors that include invalid data into one or more sectors that include only the valid data; and
change the status indicator for each of the sectors that include only the invalid data.

8. A method for managing a semiconductor memory device, wherein the semiconductor memory device includes a volatile memory, a non-volatile memory including a plurality of sectors, each of the plurality of sectors configured to store a plurality of data records, and a control module coupled to the non-volatile memory and the volatile memory, the method comprising:
setting an obsolete indicator when starting a scan of one of the sectors to indicate that all data records in the one of the sectors is invalid;
scanning the one of the sectors for invalid data records;
changing the obsolete indicator to indicate that at least one of the data records in the one of the sectors is valid when a valid data record is found in the sector; and
recording a location of the one of the sectors when the scan of the one of the sectors is complete and the obsolete indicator is still set to indicate all of the data records in the one of the sectors is invalid.

9. The method of claim 8 further comprising:
changing a sector status indicator of the sector based on the obsolete indicator.

10. The method of claim 8 further comprising:
when data is received in the non-volatile memory from the volatile memory:
writing the data in a data record that is free in one of the sectors;
searching the sectors for a previously received version of the data;
skipping searching the sectors in which data in all of the data records in the particular sector are invalid; and
when the previously received version of the data is found, marking the previously received version of the data as invalid.

11. The method of claim 10 further comprising:
decrementing an address to scan the sectors in order from most recently filled sectors to oldest filled sectors.

12. The method of claim 8 further comprising:
when data is sent to the volatile memory from the non-volatile memory:
searching the sectors for valid versions of data;
skipping searching the sectors in which all of the records in the particular sector are invalid; and
when the valid version of data are sent to non-volatile memory, changing the obsolete indicator to indicate that the valid version of data was found in the one of the sectors.

13. The method of claim 12 further comprising:
incrementing an address to scan the sectors in order from oldest filled sectors to most recently filled sectors.

14. The method of claim 13 further comprising:
compressing valid data in the non-volatile memory by copying the valid data from sectors that include invalid data into one or more sectors that include only the valid data; and
changing a status indicator for each of the sectors that include only the invalid data.

15. A computer processing system comprising:
a volatile memory;
a non-volatile memory including a plurality of sectors, each of the plurality of sectors configured to store one or more data records; and
a control module coupled to the non-volatile memory and the volatile memory, the control module is operable to manage the sectors including search the sectors for valid versions of data;
skip searching the sectors in which all of the records in the particular sector are invalid; and
when the valid versions of data are sent to the non-volatile memory, change an obsolete indicator to indicate that the valid version of data was found in the one of the sectors.

16. The computer processing system of claim 15 wherein the control module is further operable to:
increment an address to scan the sectors in order from oldest filled sectors to most recently filled sectors.

17. The computer processing system of claim 15 wherein the control module is further operable to:
when data is received in the non-volatile memory from the volatile memory:
write the data in a free record in one of the sectors;
search the sectors for a previously received version of the data;
skip searching the sectors in which all of the records in the particular sector are invalid; and
when the previously received version of the data is found, mark the previously received version of the data as invalid.

18. The computer processing system of claim 17 wherein the control module is further operable to:
decrement an address to scan the sectors in order from most recently filled sectors to oldest filled sectors.

19. The computer processing system of claim 15 wherein the control module is further operable to:
compress valid data in the non-volatile memory by copying the valid data from sectors that include invalid data into one or more sectors that include only the valid data; and
change a status indicator for each of the sectors that include only the invalid data.

20. The computer processing system of claim 15 wherein the control module is further operable to:
set the obsolete indicator when starting a search of one of the sectors to indicate that all of the data in the one of the sectors is invalid;
scan the one of the sectors for the invalid data;
change the obsolete indicator to indicate that at least one of the data in the one of the sectors is valid when valid data is found in the one of the sectors;
record a location of the one of the sectors when the scan of the one of the sectors is complete and the obsolete indicator is still set to indicate all of the data in the one of the sectors is invalid.
